(19) United States
(12) Patent Application Publication
(10) Pub. No.: US 2004/0177046 A1
(43) Pub. Date: Sep. 9, 2004

(54) Credit card protection system

(76) Inventor: Mark Ellery Ogram, Tucson, AZ (US)

Correspondence Address: Mark E. Ogram, Ste. 203, 7454 E. Broadway, Tucson, AZ, 85710, US

(21) Appl. No.: 10/382,199

(22) Filed: Mar. 5, 2003

(51) Int. Cl. H04K 1/00

(52) U.S. Cl. 705/69

(57) ABSTRACT

A security system which notifies a card-holder when a charge is made on the card-holder's account. The merchant computer communicates the account number and amount to the processing computer. Using this information, the processing computer identifies the card-holder and sends a message that the card is being used. Ideally this message is an e-mail message sent to the card-holder's cellular phone. In the preferred embodiment, the card-holder is able to respond to the proposed charge by sending a “block” to the processing computer.

### BACKGROUND OF THE INVENTION

This invention relates generally to credit cards and similar accounting systems, and more particularly to protection apparatus associated with such accounting systems.

With the advent of credit cards and e-commerce, has developed a new crime sometimes referred to as “identity theft”. Identity theft involves the assumption of another person's identity to obtain credit cards and lines of credit.

While this phenomenon has created a great deal of concern for law enforcement, by far the greater criminal threat is the simple theft of a credit card which the thief uses to purchase merchandise. The Internet has provided a “gold-mine” of potential credit card numbers.

When the theft is discovered, often several weeks later, the damage has been done and the thief is no where to be found. This leaves the merchant and the card-holder with the costs.

To make matters even worse, these types of crimes are almost impossible for the already over-taxed police to solve. The general feeling is that the loss of a few thousand dollars is not important enough for the police to use scarce resources (i.e. man-power) to solve the crime. For this reason, he theft of a credit card is considered a “safe” crime.

The same concerns relate to debit cards, charge cards, and a host of other such items.

It is clear there is a need for improved security with regards to credit cards, debit cards, charge cards, and similar accounting mechanisms.

### SUMMARY OF THE INVENTION

Within the present discussion, the term “credit card” is used for simplicity of description. The invention is not intended to be limited only to the traditional credit cards, but also includes a variety of instruments obvious to those of ordinary skill in the art, including, but not limited to, charge cards, debit cards, and a host of other account techniques. For this description “credit card” means any type of accounting system whereby payment is made.

In general, the invention provides a security system for credit card usage in which the card-holder is notified at or about the time that the credit card is used. In this context, the notification is done substantially “real-time”; that is, the notification is performed when the credit card is being processed by the credit card processing computer. In some embodiments, the notification is sent out shortly after the processing of the credit card.

The processing computer receives the account information (i.e. the credit card number) and the amount of the transaction from the merchant's computer. Using the account information, the processing computer identifies the card-holder and the card-holder's background information.

Included in the card-holder's background information is a “channel” for the card-holder to be notified when the credit card is used. The preferred method of notification is through an electronic-mail message sent to the card-holder's cellular telephone. A variety of other notification techniques are available, including, but not limited to: an e-mail sent to the card-holder's computer; a voice message sent to the card-holder's cellular phone; and, a voice message sent to the card-holder's home/business telephone.

While the actual contents of the message is not critical, the jest of the message is to notify the card-holder that the credit card is being used. Optional information includes such information as: the amount of the purchase; the merchant where the charge is being made; and, the telephone number of the merchant.

This optional information allows the card-holder to take control of the process. Assuming the credit card is being used without the authorization of the card-holder, then the card-holder is able to contact the merchant via telephone and report that the stolen card should be confiscated.

In one scenario, a card-holder sitting at his office desk, is notified by cellular phone that his credit card is being used; the card-holder can then take appropriate measures to curtail the charge; thereby eliminating the card's potential for the thief.

Besides a theft of the credit card, the invention is also useful for such activities as: monitoring a child's credit card usage (i.e. being used by an under-aged child at a bar); or., monitoring a spouse who has a betting addiction or a buying addiction.

If though the card-holder is making a purchase, his cellular telephone rings and communicates the fact that the card-holder is attempting to make a purchase. The card-holder simply “deletes” the message, thereby allowing the purchase to go through naturally.

In the preferred embodiment, the card-holder is given the opportunity to block the credit card charge. This is accomplished by providing a respond button on the cellular phone which, when pressed, informs the processing computer that the charge is not authorized.

This “blocking” call may be either voice (where the card-holder is identified by the processing computer by the telephone's caller ID- the cellular phone number) or by an e-mail (which ideally includes the cellular telephone number of the card-holder, thereby allowing the processing computer to readily identify the card-holder).

The processing computer then utilizes both the “block/no block” response together with the card-holder's authorization limit to determine if the merchant should have the charge authorized or not.

The invention, together with various embodiments thereof, will be more fully explained by the accompanying drawings and the following descriptions.

### DRAWINGS IN BRIEF

FIG. 1 graphically illustrates the operation of the preferred embodiment.

FIG. 2 is a flow chart of the merchant computer's operation in the preferred embodiment.

FIG. 3 is a flow chart of the processing computer's operation in the preferred embodiment.

FIG. 4 graphically illustrates a cellular telephone of the invention.

FIG. 5 graphically illustrates an embodiment of the invention that is used to curtail identify theft.

### DRAWINGS IN DETAIL

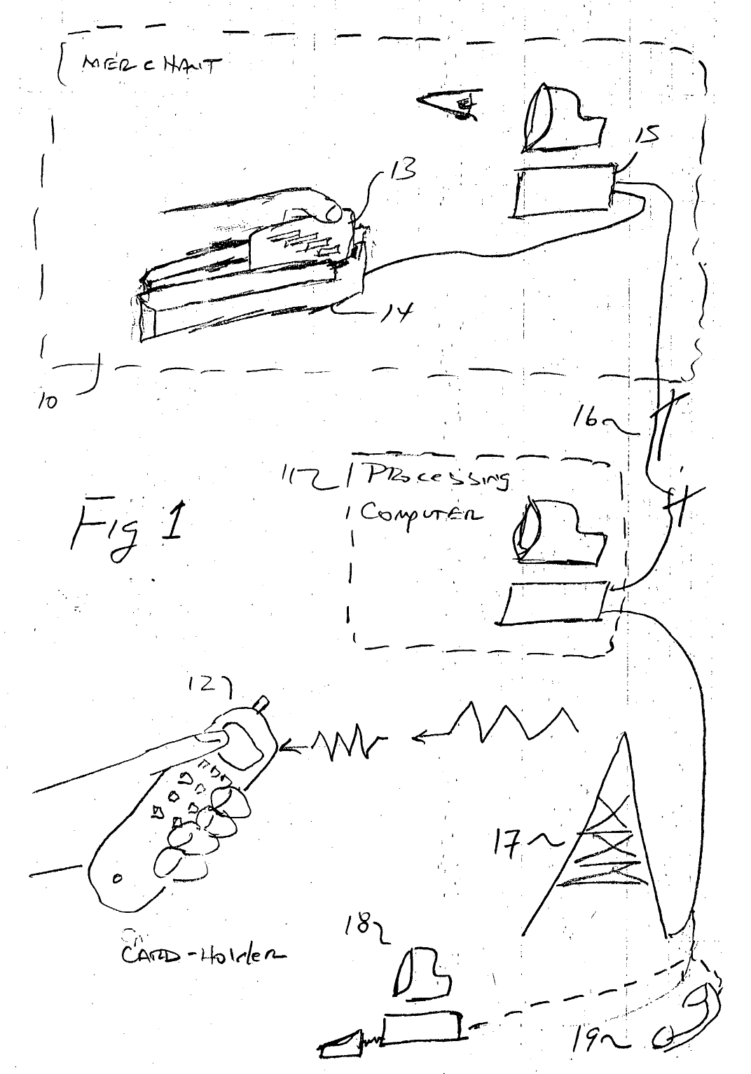

FIG. 1 graphically illustrates the operation of the preferred embodiment.

Operation begins with credit card 13 being read by reader 14 which communicates the account number to computer 15. The merchant places the amount of the purchase into computer 15 and the salient data is sent to the processing computer 11. This transmission is often done by telephone system 16.

Processing computer 11 uses the account number from the merchant's computer to identify the card-holder. In some situations, processing computer 11 has a data base containing the card-holder information; in other situations, processing computer 11 obtains the card-holder information from another source.

In this context, “processing computer” includes a variety of mechanisms, including, but not limited to: a bank's credit card computer; a store's charge card computer; and, credit card processing centers.

Once the card-holder is identified by processing computer 11, contact is made with the card-holder via cellular phone 12, via cellular system 17. Where an e-mail is used, the message is ideally sent by the Internet and then via cellular system 17.

In alternative embodiments, the message (whether textual or digital) is sent to the card-holder's computer or to the card-holders telephone.

In some embodiments, the card-holder must respond to the signal (in a reverse process: cellular phone 12 through cellular system 17 to processing computer 11) for the charge to be authorized by the processing computer 11.

In this manner, the card-holder is notified in substantially “real time” of the proposed purchase. Usually, the card-holder is the one making the purchase at merchant 10, so the card-holder merely pushes “delete” to the phone message, thereby allowing the purchase to flow naturally to be authorized; but, if the card-holder is not making the purchase, suitable immediate action can be taken.

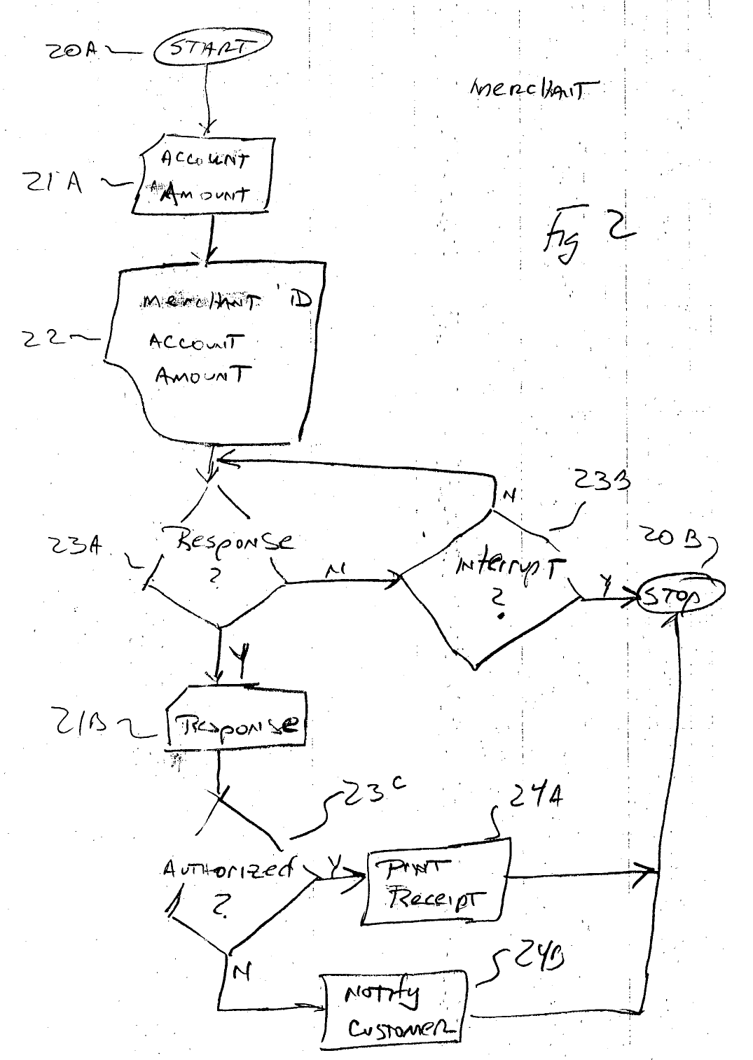

FIG. 2 is a flow chart of the merchant computer's operation in the preferred embodiment.

After start 20A, the program obtains the account number and the amount of the transaction 21A. This information, together with the merchant identification, is sent to the processing computer 22.

The program then chocks to see if a response 23A has been received. If no response has been received, the program then checks to see if the operator has generated an interrupt 23B (signaling that the transaction has been canceled). If there has been an interrupt, then the program stops 20B. If there has not been an interrupt, then the program cycles back to see if a response from the processing computer has been received 23A.

Upon the receipt of a response from the processing computer, the response is read 21B and a determination is made on whether the response is an authorization or not 23C. If the transaction has been authorized, a receipt is printed 24A and the program stops 20B. Should the transaction not be authorized, the customer is notified 24B and the program stops 20B.

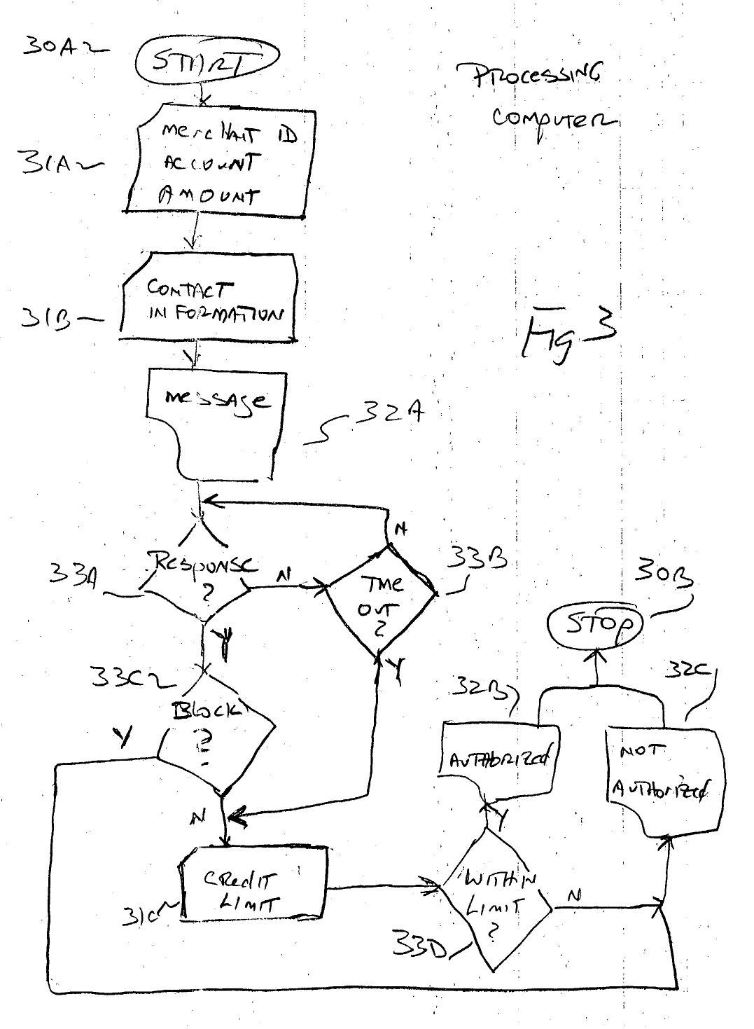

FIG. 3 is a flow chart of the processing computer's operation in the preferred embodiment.

Once the program starts 30A within the credit card processing computer, the merchant identification, credit card account number, and amount of purchase is received 31A from the merchant. Using the credit card account number, the contact information for the card holder is determined 31B.

While the processing computer often has a massive data base of credit card accounts, in some situations, the credit card numbers and background information is stored at another location; in this case, the information is retrieved from the remote computer's memory.

A message is then formulated and sent to the card holder 32A based upon the identified contact information. The program then checks to see if a response from the card-holder has been received 33A; if not, then a check for the lapse of the time-out 33B is made. Ideally the time-out is set at fifteen to thirty seconds. If the time-out 33B has not occurred, the program cycles back.

Time out is used to allow the process to proceed should the card-holder decide not to respond or is unable to respond at that time.

If a response is received, a decision on if the response was to “block” the purchase is made 33C. If a “block” from the card-holder is received, then the program issues a “Not Authorized” signal 32C to the merchant and the program stops 30B.

If “no block” is received, or the time-out has transpired, then the card-holder's available credit limit is determined 31C. An analysis of the available credit limit and the amount of the purchase is made 33D.

If the purchase is outside of the available limit, then the merchant is notified that the transaction is not authorized 32C and the program stops 30B; if the purchase is' within the available limit, then the merchant is notified that the transaction is authorized 32B and the program stops 30B.

While the above flow-chart illustrates one method to perform the present invention, those of ordinary skill in the art readily recognize a variety of other techniques that will perform these functions.

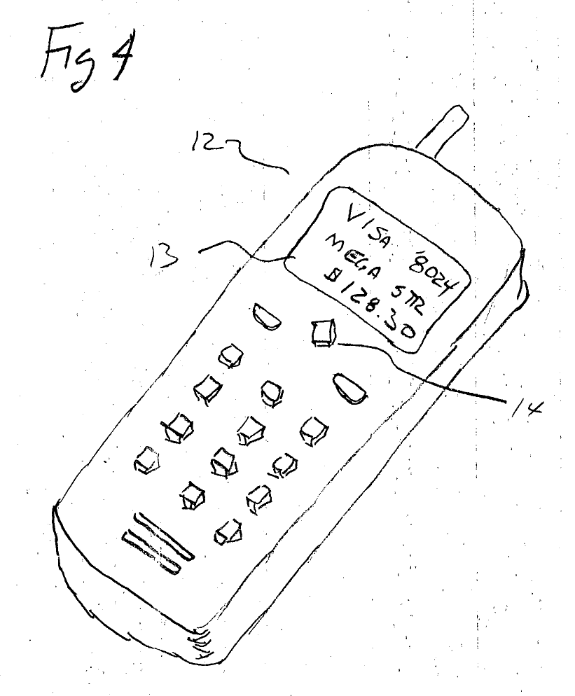

FIG. 4 graphically illustrates a cellular phone of the invention.

Cellular phone 12 has display 13 on which the electronic message “VISA '8024, MEGA STORE, $128.30” is communicated to the card-holder. In the preferred embodiment, button 14 permits the card-holder to “block” the transaction. By pressing button 14, cellular phone 12 transmits a signal back to the processing computer, thereby effectively blocking the transaction.

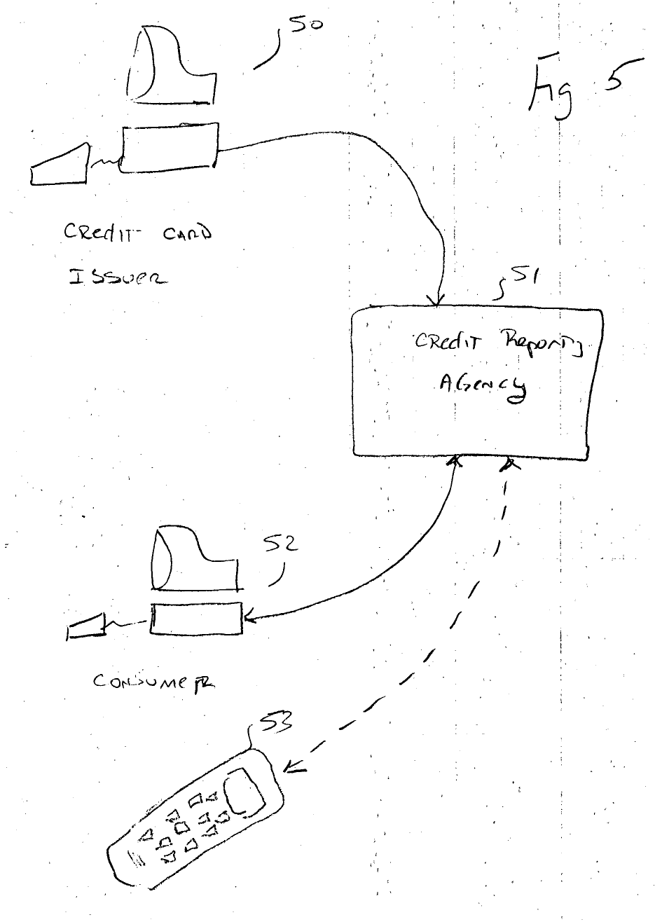

FIG. 5 graphically illustrates an embodiment of the invention used to curtail identify theft.

When credit card issuer 50 wants to establish the credit-worthiness of a potential credit card holder, an inquiry is made to a credit reporting agency 51. Credit reporting agency 51 includes a variety of companies who keep track of an individual's (and also a company's) credit history. Typically the inquiry is done using the individual's social security number.

When credit reporting agency 51 receives an inquiry which may or may not result in a credit card, or credit being issued, then credit reporting agency 51 reports this inquiry to computer 52 of the consumer. This communication is ideally done by e-mail. The consumer, when reading the e-mail at a later time, learns of the credit inquiry is able to respond to the credit reporting agency 51 on whether the consumer wants to “block” or “not block” the credit report.

If the inquiry from the credit card issuer is being made as a result of an identity theft, then the “blocking” of the report and subsequent reporting by the credit reporting agency 51 stops the theft immediately.

Note, in this embodiment, notification of the consumer is not necessarily in “real-time”.

Another method of reporting to the consumer is through cellular telephone 53.

It is clear that the prevent invention provides for a highly improved security system for credit cards, debit cards, charge cards, and other similar accounting mechanisms.

What is claimed is:

1. An account security system comprising:
a) a merchant computer having means for communicating account indicia and an amount to a remote computer;
b) a user interface, remote from said merchant computer, having means for,
1) receiving information from a remote source, and,
2) communicating said information to a user; and,
c) a processing computer having means for,
1) receiving account indicia and amount from said merchant computer, and
2) in response to said account indicia, communicating selected information to said user interface.

2. The account security system according to claim 1,
a) wherein said user interface includes, in response to user input, means for transmitting an acceptance flag to said processing computer; and,
b) wherein said processing computer includes,
1) means for receiving said acceptance flag, and,
2) in response to said acceptance flag and accounting data associated with said account indicia, means for transmitting an authorization flag to said merchant computer.

3. The account security system according to claim 2, wherein said user interface is portable.

4. The account security system according to claim 3, wherein said user interface includes a cellular telephone.

5. The account security system according to claim 2, wherein said user interface includes:
a) a user computer; and,
b) wherein the means for communicating a flag of said user interface includes means for transmitting electronic-mail to said processing computer.

6. The account security system according to claim 5, wherein said user computer includes means for summing amounts reported by said processing computer over a selected period of time.

7. The account security system according to claim 1, wherein said selected information communicated by said processing computer includes an identification of a merchant controlling said merchant computer.

8. The account security system according to claim 7, wherein said selected information communicated by said processing computer includes a telephone number for the merchant.

9. The account security system according to claim 8,
a) wherein said user interface includes a cellular telephone; and,
b) wherein said cellular telephone includes means for activating said telephone number on said cellular telephone.

10. A payment system comprising:
a) a first computer having means for communicating account indicia and an amount to a remote computer;
b) a cellular telephone having a user interface; and,
c) a second computer having,
1) means for receiving account indicia and amount from the first computer,
2) communicating selected information to said cellular telephone, and,
3) means for communicating an authorization to the first computer.

11. The payment system according to claim 10, wherein said cellular telephone includes means for transmitting an acceptance flag to said second computer.

12. The payment system according to claim 11, wherein said second computer further includes:
a) means for receiving said acceptance flag; and,
b) wherein said means for communicating an authorization operates in response to said acceptance flag and accounting data associated with said account indicia.

13. The payment system according to claim 10, wherein said selected information communicated by said second computer includes an identification of a user controlling said first computer.

14. The payment system according to claim 13, wherein said selected information communicated by said second computer includes a telephone number for a user of said first computer.

15. A security system comprising:
a) a merchant computer having means for communicating account indicia and amount;
b) a user interface remote from said merchant computer; and,
c) a processing computer having means for,
1) receiving account indicia and amount from said merchant computer, and
2) in response to said account indicia, communicating selected information to said user interface for communication to a user of said user interface.

16. The security system according to claim 15,
a) wherein said user interface includes means for transmitting an acceptance flag to said processing computer; and,
b) wherein said processing computer includes, in response to said acceptance flag and accounting data associated with said account indicia, means for transmitting an authorization flag to said merchant computer.

17. The security system according to claim 16, wherein said user interface includes a cellular telephone.

18. The security system according to claim 17, wherein said selected information communicated by said processing computer includes an identification of a merchant controlling said merchant computer.

19. The security system according to claim 18, wherein said selected information communicated by said processing computer includes a telephone number for the merchant.
